(19) United States
(12) Patent Application Publication
(10) Pub. No.: US 2024/0381330 A1
(43) Pub. Date: Nov. 14, 2024

(54) Method and Apparatus for Processing Transmission Based on Uplink Sub-Band

(71) Applicant: ZTE Corporation, Shenzhen (CN)

(72) Inventors: Wei GOU, Shenzhen (CN); Xianghui HAN, Shenzhen (CN); Jing SHI, Shenzhen (CN); Xingguang WEI, Shenzhen (CN); Shuaihua KOU, Shenzhen (CN)

(73) Assignee: ZTE Corporation, Shenzhen (CN)

(21) Appl. No.: 18/777,849

(22) Filed: Jul. 19, 2024

Related U.S. Application Data
(63) Continuation of application No. PCT/CN2022/123458, filed on Sep. 30, 2022.

(51) Int. Cl. H04W 72/0453; H04L 5/14; H04W 72/0446; H04W 72/1268; H04W 72/231; H04W 72/566

(52) U.S. Cl. CPC H04W 72/0453; H04L 5/14; H04W 72/0446; H04W 72/1268; H04W 72/231; H04W 72/566

(57) ABSTRACT

This disclosure is generally directed to wireless communication systems and methods and relates particularly to resource configuration and allocation for time-division duplex. The various implementations described in detail below concern scheduling and allocation of time-frequency communication resources within a uplink subband configured within a set of resources that are otherwise configured for downlink transmission or for transmission with a flexible direction. Various embodiments are described below for dynamically scheduling downlink transmissions within the resources of the uplink subband, for modifying/extending resources for the uplink subband in order to improve uplink and downlink transmission resource balance in real-time. The disclosure below further provides various implementations for resolving uplink and downlink transmission time conflict within the uplink subband and for transmitting downlink reference signal over the UL subband.

### TECHNICAL FIELD

This disclosure is generally directed to wireless communication systems and methods and relates particularly to resource configuration and allocation for time-division duplex.

### BACKGROUND

Over-the-air radio resources are critical components in wireless communications networks. Effective communications rely heavily on efficient allocation these resources. Communications between base stations and terminal devices, in either uplink direction or downlink direction share these resources. Reduction and removal of signal interference and conflict during such sharing is often a critical aspect in designing an efficient wireless communication system.

### SUMMARY

This disclosure is generally directed to wireless communication systems and methods and relates particularly to time-division duplex of frequency resources.

In some example implementations, a method performed by a wireless terminal device is disclosed. The method may include receiving an allocation of a first set of time-frequency resources as downlink or direction-flexible time-frequency resources from a wireless access network node; and receiving a configuration of an uplink subband for uplink transmission from the wireless access network node, the uplink subband occupying a contiguous resource blocks in frequency and a set of symbols in time within the first set of time-frequency resources.

In the example implementation above, the method may further include receiving a scheduling of a second set of time-frequency resources for an uplink transmission from the wireless access network node, the second set of time-frequency resources are partially within and partially outside of the uplink subband in time.

In any one of the implementations above, the configuration of the uplink subband is received from the wireless access network node via semi-static Radio Resource Control (RRC) signaling or a Media Access Control (MAC) control element (CE).

In any one of the implementations above, a portion of the second set of time-frequency resources outside of the uplink subband is implemented as a time-domain adjustment to the uplink subband.

In any one of the implementations above, the time-domain adjustment to the uplink subband is only valid during the scheduling of the second set of time-frequency resources for the uplink transmission, or is valid until a next time-domain adjustment to the uplink subband, or is valid for a predetermined or configured period of time following the scheduling of the second set of time-frequency resources for the uplink transmission.

In any one of the implementations above, the scheduling of the second set of time-frequency resources is received from the wireless access network node as a Downlink Control Information (DCI) message.

In any one of the implementations above, the configuration of the uplink subband is transmitted in response to the wireless access network node receiving a capability report from the wireless terminal device, the capability report indicating that the wireless terminal device supports a subband full-duplex (SBFD) or the wireless terminal device supports using the second set of time-frequency resources for the uplink transmission.

In any one of the implementations above, the DCI message comprises one or more parameters indicating to the wireless terminal device a time and frequency location of the second set of time-frequency resources.

In any one of the implementations above, the DCI message comprises an indicator that indicates to the wireless terminal device that the uplink subband is to be extended according to the second set of time-frequency resources.

In any one of the implementations above, the wireless access network node is prohibited from further scheduling any resources that co-locate in time with a portion of the second set of time-frequency resources that is outside of the uplink subband and within a frequency resource range of the uplink subband.

In any one of the implementations above, flexible resources are configured by a signaling from the wireless access network node for the uplink subband in time-frequency resource of the uplink subband; or a portion of time-frequency resources of the uplink subband are allowed to be configured by the signaling as flexible resources.

In any one of the implementations above, transmission direction of the flexible resources is determined based on direction of transmissions scheduled in the flexible resources.

In any one of the implementations above, the flexible resources configured in the uplink subband comprise one or more OFDM symbols across an entire frequency range of the uplink subband.

In any one of the implementations above, the flexible resources configured in the uplink subband comprise one or more frequency resource blocks across an entire OFDM symbol range of the uplink subband.

In any one of the implementations above, the signaling comprises an RRC signaling.

In any one of the implementations above, the flexible resources are configured in response to the wireless access network node receiving a capability report from the wireless terminal device, the capability report indicating that the wireless terminal device supports a subband full-duplex (SBFD) or the wireless terminal device supports the flexible resources in the uplink subband.

In another example implementation, a method performed by a wireless terminal is disclosed. The method may include receiving an allocation of a first set of time-frequency resources as downlink or direction-flexible time-frequency resources from a wireless access network node; receiving a configuration of an uplink subband for uplink transmission from the wireless access network node, the uplink subband occupying a contiguous resource blocks in frequency and a set of OFDM symbols in time within the first set of time-frequency resources; and receiving a downlink transmission in the configured uplink subband from the wireless access network node.

In the implementation above, receiving the downlink transmission in the configured uplink subband may include receiving a signaling from the wireless access network node to schedule the downlink transmission in at least one portion of the uplink subband.

In any one of the implementations above, the at least one portion of the uplink subband correspond to no other portions of the uplink subband that overlap with the at least one portion of the uplink subband and that are scheduled for uplink transmission.

In any one of the implementations above, the signaling is included in a DCI from the wireless access network node when scheduling the downlink transmission.

In any one of the implementations above, the wireless access network node is prohibited from further scheduling an uplink transmission over second set of time-frequency resources overlapping with the at least one portion of the configured uplink subband in time and within a frequency resource range of the configured uplink subband.

In any one of the implementations above, the method may further include determining a first priority level for the uplink subband, the first priority level being used as a basis for determining whether a downlink transmission is allowed to be scheduled in the uplink subband.

In any one of the implementations above, the downlink transmission is allowed if the first priority level of the uplink subband is lower than a second priority level associated with the downlink transmission; and the downlink transmission is prohibited if first priority level of the uplink subband is higher than the second priority level associated with the downlink transmission.

In any one of the implementations above, the method may further include resolving scheduling conflict between two downlink transmissions or between a downlink transmission and uplink transmission of a same priority with time overlap within the uplink subband by retaining a transmission inside a frequency range of the uplink subband and by discarding the transmission outside the frequency range of the uplink subband.

In any one of the implementations above, the method may further include prohibiting scheduling a dynamic PDSCH downlink transmission and a dynamic PUSCH/PUCCH by a same PDCCH with overlapping time within the uplink subband.

In any one of the implementations above, the method may further include resolving a scheduling conflict between a dynamic PDSCH downlink transmission and a dynamic PUSCH/PUCCH uplink transmission overlapping in time within the uplink subband based on a timing of respective scheduling PDCCH for the dynamic PDSCH downlink transmission and the dynamic PUSCH/PUCCH uplink transmission.

In any one of the implementations above, the method may further include resolving a scheduling conflict between a dynamic PDSCH downlink transmission and a semi-static PUSCH/PUCCH uplink transmission overlapping in time within the uplink subband based on an OFDM symbol level time separation between respective scheduling PDCCH for the dynamic PDSCH downlink transmission and the semi-static PUSCH/PUCCH uplink transmission.

In any one of the implementations above, the method may further include resolving a scheduling conflict between a dynamic PDSCH downlink transmission and a semi-static PUSCH/PUCCH uplink transmission overlapping in time within the uplink subband by retaining the semi-static PUSCH/PUCCH uplink transmission and by discarding the dynamic PDSCH downlink transmission.

In any one of the implementations above, the method may further include resolving a scheduling conflict between a semi-static PDSCH downlink transmission and a dynamic PUSCH/PUCCH uplink transmission overlapping in time within the uplink subband by retaining the dynamic PUSCH/PUCCH uplink transmission and by discarding the semi-static PDSCH downlink transmission.

In any one of the implementations above, the method may further include resolving a scheduling conflict between a semi-static PDSCH downlink transmission and a semi-static PUSCH/PUCCH uplink transmission overlapping in time within the uplink subband by retaining the semi-static PUSCH/PUCCH uplink transmission and by discarding the semi-static PDSCH downlink transmission.

In any one of the implementations above, the method may further include the downlink transmission is configured for transmitting downlink reference signals in the uplink subband.

In some other implementations, methods performed by a wireless access network node (or a base station) are disclosed. These methods correspond to the methods performed by the wireless terminal device above during their communication in semi-statically and dynamically configuring and reconfiguring the uplink subband, uplink transmission/reception and downlink transmission/reception over the uplink subband.

In some other implementations, a wireless communications apparatus is disclosed. The wireless communication apparatus may include a processor and a memory, wherein the processor is configured to read code from the memory and implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations or UEs and a wireless access network node in communication with one another via an over-the-air radio communication interface.

FIG. 3 shows an example time slot structure illustrating time-frequency resources for an uplink subband.

FIG. 4 shows an example time slot structure illustrating time-frequency resources for an uplink subband.

FIG. 5 shows an example time slot structure illustrating time-frequency resources for an uplink subband.

FIG. 6 shows an example time slot structure illustrating adjustment of time-frequency resources for an uplink subband.

FIG. 7 shows an example time slot structure illustrating adjustment of time-frequency resources for an uplink subband.

FIG. 8 shows an example time slot structure illustrating adjustment of time-frequency resources for an uplink subband.

FIG. 9 shows an example time slot structure illustrating adjustment of time-frequency resources for an uplink subband.

FIG. 10 shows an example time slot structure illustrating a configuration of downlink resources within an uplink subband.

FIG. 11 shows an example time slot structure illustrating a configuration of downlink resources within an uplink subband.

FIG. 12 shows an example time slot structure illustrating a configuration of downlink resources within an uplink subband.

FIG. 13 shows an example time slot structure illustrating a configuration of downlink resources within an uplink subband.

FIG. 14 shows an example time slot structure illustrating a configuration of downlink resources within an uplink subband.

FIG. 15 shows an example time slot structure illustrating a configuration of downlink resources within an uplink subband.

FIG. 16 shows an example time slot structure illustrating a configuration of downlink resources within an uplink subband.

### DETAILED DESCRIPTION

The technology and examples of implementations and/or embodiments described in this disclosure can be used to facilitate efficient configuration and allocation of uplink and downlink time-frequency communication resources in wireless networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is generally directed to wireless communication systems and methods and relates particularly to resource configuration and allocation for time-division duplex. The various implementations described in detail below concern scheduling and allocation of time-frequency communication resources within an uplink subband configured within a set of resources that are otherwise configured for downlink transmission or for transmission with a flexible direction. Various embodiments are described below for dynamically scheduling downlink transmissions within the resources of the uplink subband, for modifying/extending resources for the uplink subband in order to improve uplink and downlink transmission resource balance in real-time. The disclosure below further provides various implementations for resolving uplink and downlink transmission time conflict within the uplink subband and for transmitting downlink reference signal over the UL subband.

### Wireless Network Overview

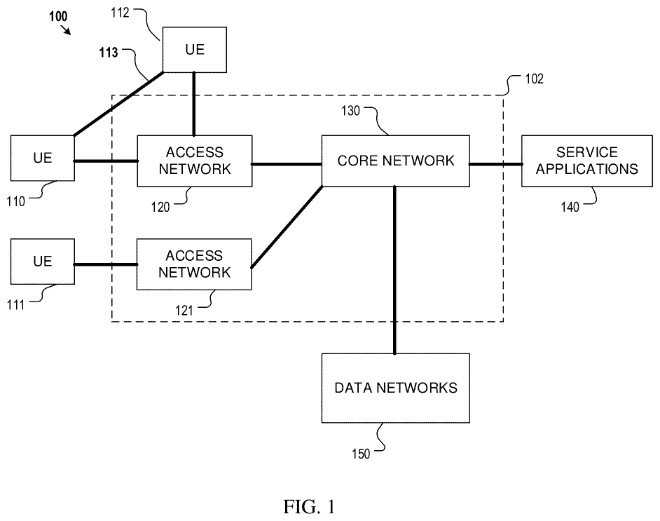

An example wireless communication network, shown as 100 in FIG. 1, may include wireless terminal devices or user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

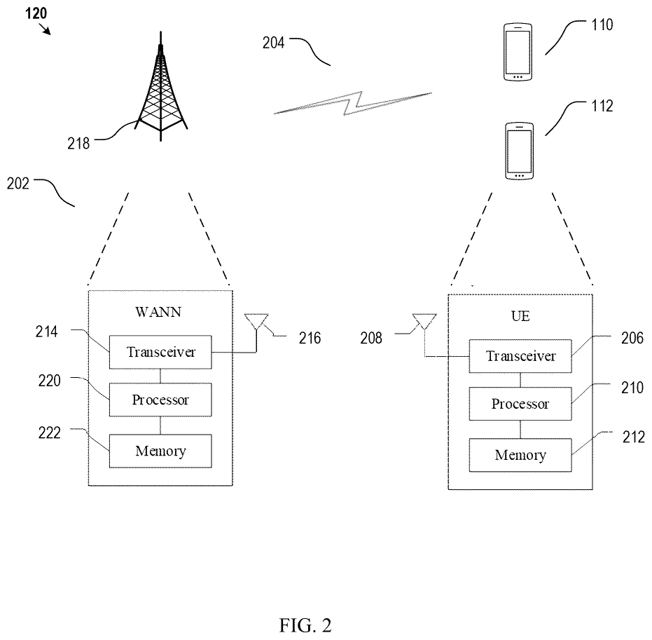

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

### UL Subband

In wireless access communication networks, for a carrier or a frequency band configured for Time Division Duplex (TDD), each time slot is configured either for downlink (DL) or uplink (UL) communications. A time slot may be further configured as a flexible slot which may be used for either DL or UL communication, but not both. The term “time slot” is herein alternatively referred to as “slot” for simplicity. Because DL traffic usually dominates over the UL traffic in wireless access network, DL slots are usually configured more in number than UL slots. An example typical cyclic slot structure may be DDDSU, where D represents a DL slot, U represents a UL slot, and S represents a flexible slot. A flexible slot, for example, may contains DL symbols and UL symbols. UL slots are thus usually fewer in number and are often discontinuous, thereby limiting the performance of UL transmission. For example, the UL data volume may be limited, and more importantly, the timeliness and edge coverage of UL transmission are relatively poor due to frequent UL slot discontinuity.

In some example implementations, a subband full-duplex (SBFD) technology may be employed to provide improved UL support. For example, a time-frequency resource containing several consecutive resource blocks (RBs) in the frequency domain and several consecutive OFDM symbols within a DL or flexible slot may be configured as an UL subband. In other words, a piece of time-frequency resource, referred to as a UL subband, may be configured to support a UL transmission within an otherwise DL or flexible slot.

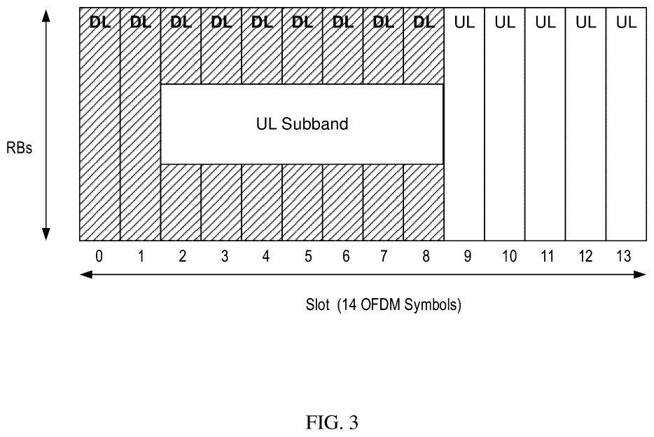

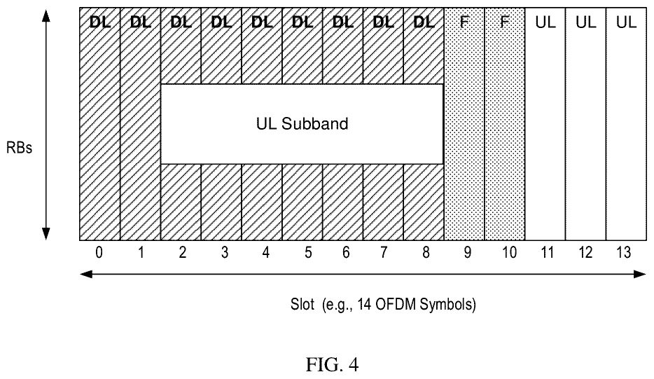

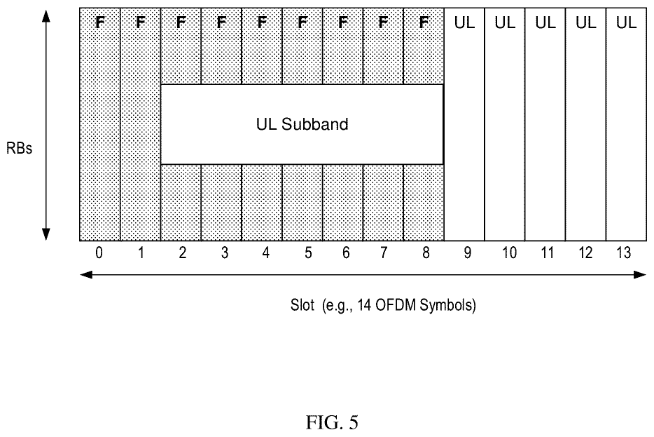

Examples of SBFD time-frequency resource configuration are illustrated in FIGS. 3-5. In each of FIGS. 3-5, the horizontal axis represents a time slot in units of OFDM symbols whereas the vertical axis represents frequency resources in resource blocks (RBs). A particular time slot may be configured with an allocation of DL, UL, or F (flexible) OFDM symbols (OFDM symbols are hereinafter alternatively referred to as symbols for simplicity). For example, the time slot in FIG. 3 includes 9 DL symbols followed by 5 UL symbols. For another example, the time slot in FIG. 4 includes 9 DL symbols followed by 2 F symbols and then followed by 3 UL symbols. For yet another example, the time slot in FIG. 5 includes 9 F symbols followed by 5 UL symbols. In each of FIGS. 3-5, an example UL subband is configured, occupying one or more RBs in frequency and several (e.g., 7) OFDM symbols in time and within the otherwise DL (FIG. 3 and FIG. 4) or F (FIG. 5) OFDM symbols. Those having ordinary skill in the art understand that the DL, UL, F symbol configuration and the UL subband configuration shown in FIGS. 3-5 are merely non-limiting examples.

In some example implementations of SBFD above, the UL subband may be configured by RRC signaling. The allocation and reallocation of UL subbands within the otherwise DL or F time-frequency resources are thus semi-static rather than fully dynamic. As a result, such implementations, while allowing for overall additional UL support when needed, is quite limited in or incapable of providing dynamic balancing of UL and DL resources according to the real-time needs of various services and applications. In particular, SBFD based on RRC signaling does not provided dynamic and swift reconfiguration of the UL subband when UL traffic decreases and more resources are needed for DL transmission.

One potential solution for providing more real-time allocation in SBFD is to allow for dynamic scheduling of DL transmission within the time-frequency resources of a UL subband already configured by RRC, as described in further detail in the various embodiments below.

Further, if DL transmission is allowed within the time-frequency resources of the UL subband, it will cause new problems. For example, within the time-frequency resources of the UL subband, various potential DL transmissions and various potential UL transmissions may overlap in the time domain. How to solve their time-domain overlap? This application also presents some solutions.

Additionally, in this disclosure, a new UL scheduling transmission based on UL subband is also provided, which can dynamically balance DL resources and UL resources, thereby improving resource utilization.

### Dynamic Adjustment of UL Subband to Include Additional Symbols

In some example implementations, a UL transmission in the as-configured UL subband may be dynamically adjusted, e.g., extended, in the slot in time domain to include additional OFDM symbols outside of the as-configured the UL subband when it is determined that more UL time-frequency resources are needed in real-time.

In such a manner, the original RRC allocation by a base station of the UL subband within the otherwise DL or F time slots may be determined based on expected UL transmission needs of the service or application associated with a particular RRC session. The semi-static RRC allocation of the UL subband may be geared towards a conservative end (smaller UL resource allocation), considering that UL subband may be adjusted/extended dynamically in time. During the RRC session, if the UL traffic becomes heavy than expected and the conservative semi-static UL subband allocation becomes insufficient for effectively handling UL traffic at that time, a UL transmission scheduled within the UL subband may be dynamically adjust/extended in the time-domain into additional OFDM symbols outside of the UL subband. In some example implementations, the extended UL symbols may occupy the RBs within those of the semi-statically configured UL subband. In some particular implementations, the extended UL symbols may occupy the same RBs of the semi-statically configured UL subband allocated/scheduled for the UL transmission.

The example implementations above may be advantageous in providing adaptive and dynamic balancing between UL and DL resource allocation while keep any previous subband filtering technology (including filter design and frequency locking, and the like) intact, because the frequency domain resources of the UL subband may not need to change (only the time resources are extended), which is beneficial for subband filter design and frequency locking.

The time-frequency resources of the UL subband, including the extended symbols within the RBs of the UL subband, may be used for any UL transmission, including but not limited to any one of the PUSCH (physical uplink shared channel), PRACH (physical random-access channel), PUCCH (physical uplink control channel), or SRS (sounding reference signal) scheduled by DCI (downlink control information) and/or configured by RRC signaling. PUCCH communications, for example, include uplink communications carrying HARQ-ACK (hybrid automatic repeat request acknowledgement), CSI (channel status indication) or SR (scheduling request). HARQ-ACK, for example, includes uplink HARQ-ACK corresponding to PDSCH (physical downlink shared channel) communications and uplink HARQ-ACK corresponding to PDCCH (physical downlink control channel) communications.

In some example implementations, the dynamic time extension of the UL transmission may be scheduled with DCI. In a particular example implementation, a UL subband may be semi-statically configured for a UE such that the UE is aware of the time-frequency resources of the UL subband. Then, when a DCI from a corresponding base station is used in the PDCCH to schedule an uplink transmission (e.g., PUSCH/PUCCH/PRACH transmission) using the UL subband resources, a parameter may be is introduced into the DCI for achieving the dynamic time extension described above. This parameter, for example, may be included for one of the following purposes:
(1) It may be used to notify that the time domain resources of the UL subband are adjusted, and the time domain resources of the adjusted UL subband further include symbols outside the UL subband as configured/indicated/scheduled by the DCI for UL transmission (e.g., PUSCH/PUCCH/PRACH transmission). In this case, the validity time window of the adjusted time-domain resources of the UL subband as scheduled by the DCI may be one of the following: the adjusted time domain resources of the UL subband by the DCI that schedules UL transmission is only valid for the current UL transmission scheduling; or the adjusted time-domain resources of the UL subband by the DCI that schedules UL transmission is valid until the next time the time-domain resources of the UL subband are readjusted by another DCI that schedules UL transmission; or the adjusted time-domain resources of the UL subband is valid in a subsequent predefined or configured time period once the adjustment is indicated in the DCI that schedules the current UL transmission. With this purpose, the time domain resources of UL subband are adjusted during the various optional time windows above, so all the symbols scheduled for UL transmission are part of the adjusted UL subband during the valid time window.
(2) It may be used to notify that the scheduled uplink transmission (e.g., PUSCH/PUCCH/PRACH transmission) is to be transmitted according to the symbols configured/indicated/scheduled for the uplink transmission in the DCI, even if the symbols so scheduled for the uplink transmission (e.g., PUSCH/PUCCH/PRACH transmission) exceed the time domain resources of the UL subband. With this purpose, the time domain resources of UL subband are not adjusted, but part of the symbols scheduled for UL transmission can be outside the UL subband in the time domain.

In some example implementations, the above DCI associated with a PUSCH transmission may correspond to a DCI format used for scheduling PUSCH transmission. The DCI associated with a PRACH transmission may correspond to a DCI format used to trigger a PRACH transmission. Likewise, the DCI associated with a PUCCH transmission may correspond to a DCI format that schedules a PDSCH or to a DCI that does not schedule a PDSCH. In some example implementations, a dedicated or special DCI format for the DCI may be configured by the base station to schedule/indicate UL transmissions in the UL subband. Alternatively, a dedicated or special CORESET/PDCCH monitoring occasion (MO) for the DCI may be configured by the base station to schedule/indicate UL transmissions in the UL subband.

Thus, this method does not require new/dedicated DCI or DCI format for modifying the UL subband, but reuses the DCI formats and framework for scheduling UL transmission, and only by adding the parameter or parameters above to the DCI. If the base station wants to adjust the time domain resources of a UL subband, the base station can set the value of the parameter as, for example, an indicator or flag, to a certain state A to indicate that the UL subband is to be modified. For example, the base station sets the value of the parameter in the DCI to a certain state A, and schedules a UL transmission (e.g., a PUSCH/PUCCH/PRACH transmission) through the DCI, then the symbols configured/indicated/scheduled in the DCI for the UL transmission are automatically configured for the UL subband and for the UL transmission. In such a manner, the time domain resources of the UL subband are dynamically adjusted/extended while scheduling the UL transmission, so that the dynamic balance of the UL resources and the DL resources can be achieved. If the uplink transmission is a PUSCH, the PUSCH may include with UL SCH and without UL SCH.

The parameter above may be implemented in various manners and include more additional items. For example, a set of parameters may be used to represent the number and location of UL symbol adjustment/extension. These parameters may be included in DCI. In some other implementations, the DCI may only need to include an indicator for indicating whether there is an adjustment/extension to the UL subband. The parameters specifying an actual manner in which the adjustment/extension should be made may be included in the scheduling of the DCI, or alternatively, be preconfigured/predefined, or may be semi-statically configured via, e.g., RRC signaling or MAC CE signaling. Such preconfigured/predefined or semi-statically configured parameters indicating the adjustment/extension manner may become effective when the indicator in the DCI is present or activated, and may be otherwise ineffective. There may be different options in the manners for the adjustment/extension, represented by different sets of preconfigures/predefined or semi-statically configured parameters. These sets of parameters may be identified via indexes. The indicator in the DCI thus may additionally specify, e.g., using an index, a particular set of preconfigures/predefined or semi-statically configured parameters indicating the manner of adjustment/extension of symbols in time domain of the UL subband.

In some implementations, the parameter(s) can be configured for the UE by higher layer signaling (such as RRC signaling or MAC CE signaling). Once RRC configures the parameter to exist for the UE, the parameter is then includable in the DCI for dynamic scheduling of UL transmission outside of the UL subband. Otherwise the parameter(s) may not be included in the DCI for dynamic scheduling.

In some other implementations, the parameters or indicators above may not need to be included in the DCI or be reconfigured. Instead, the UE and the base station may follow predefined and agreed-upon rules for dynamic scheduling of UL transmission through DCI. For example, the predefined and agreed-upon rules are one of the two purposes corresponding to the above parameter. For example, for a UE supporting SBFD, the DCI from the base station may schedule a UL transmission (e.g., PUSCH/PUCCH/PRACH transmission) in the UL subband, and the scheduled time domain resources configured/indicated for the UL transmission may exceed (or otherwise be outside of) the time domain resources of the UL subband, then the UE should perform the UL transmission in the configured/indicated resources including the time resources outside of the time-domain range of the UL subband but with frequency domain resources for the scheduled UL transmission still being within the frequency domain resource range of the UL subband. In this way, if the base station needs to schedule a UL transmission for SBFD UE through DCI, then the time domain resources of the UL transmission can be configured or indicated to exceed the time domain resources of the UL subband, and the UL transmission is performed in the configured/indicated in the time domain resource.

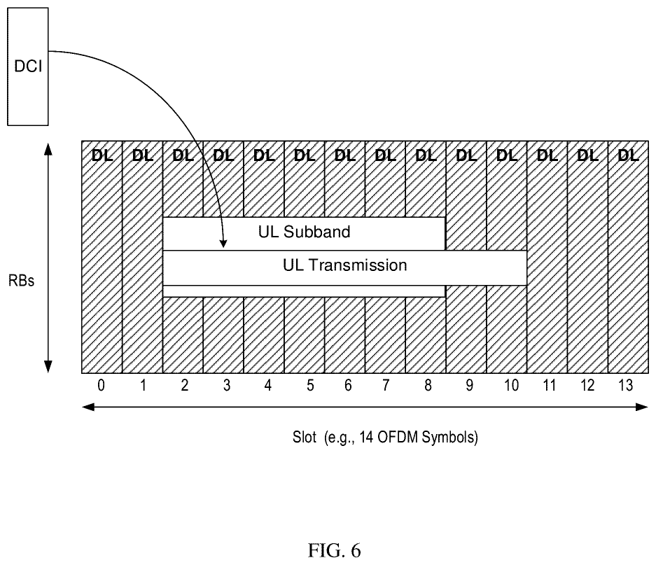

Examples of dynamic time-domain extension of the semi-statically configured UL subband are illustrated in FIGS. 6-9. Again, in FIGS. 6-9, the horizontal axis represents a time slot in units of OFDM symbols whereas the vertical axis represents frequency resources in RBs. In FIG. 6, for example, the UL subband start at symbol #2 and ends at symbol #8. A UL transmission may be scheduled by the base station via DCI for all or a portion of the frequency resources and for adjusted time-domain resources beyond the UL subband (e.g., the base station may schedule a PUSCH/PUCCH/PRACH in the UL subband through a scheduling DCI in the PDCCH). In the example of FIG. 6, a number of additional symbols outside of the UL subband (e.g., symbol #9 and #10 outside of the UL subband in addition to symbol #2 through #8 within the UL subband) may be scheduled by the DCI for the UL transmission. Specifically, the base station may schedule the PUSCH/PUCCH/PRACH transmission as occupying symbol #2 through #10. The time-domain location of the UL transmission indicated in FIG. 6 with the time adjustment may be specified in the scheduling DCI.

The DCI may include the parameter above (alternatively referred to as an indicator, or flat) with the value A to signal the UE to perform the UL transmission in the scheduled time domain resource symbol #2 to symbol #10. For the UE to not perform the UL transmission extending outside of the UL subband under such scheduling, the DCI would set the value of the parameter to B rather than A. When the parameter is set at value A, it may further indicate a modification of the UL subband to include resourced by the DCI outside of the semi-statically configured UL subband within a valid time window as described above. In other words, when the scheduling DCI above include the parameter with value B, then the UE performs the UL transmission only in the scheduled time domain resource symbol #2 to symbol #8, and does not perform UL transmission in symbol #9 to symbol #10.

To describe the example implementation above in another manner, it is noted that in FIG. 6, in one DL slot, one UL subband is configured in the time domain to occupy a total of 7 consecutive symbols from symbol #2 to symbol #8. The base station schedules an example PUSCH/PUCCH/PRACH in the UL subband through a DCI in the PDCCH. The PUSCH/PUCCH/PRACH may be indicated by the DCI to occupy time domain resources from symbol #2 to symbol #10. While symbols #9 and #10 are not configured for the UL subband (here symbols #9 and #10 are originally configured as DL symbols, but can also be UL symbols or flexible symbols). If the base station sets the value of a parameter in the DCI to notify that the time domain resources of the UL subband are adjusted to include the symbols configured/indicated for the PUSCH/PUCCH/PRACH in the DCI. As such, the UE should consider that symbol #9 and symbol #10 are dynamically configured for the UL subband to transmit the PUSCH/PUCCH/PRACH. That is, the UL subband is dynamically adjusted to contain symbol #2 to symbol #10 for a valid time window as described above. In this way, the UE transmits the PUSCH/PUCCH/PRACH in symbol #2 to symbol #10 of the UL subband. Or, if the base station sets the value of the parameter in the DCI to notify that the PUSCH/PUCCH/PRACH is transmitted according to the symbols configured/indicated for the PUSCH/PUCCH/PRACH in the DCI. In this way, the UE transmits the PUSCH/PUCCH/PRACH in symbol #2 to symbol #10 of the UL subband, although symbol #9 and #10 are not originally configured for the UL subband.

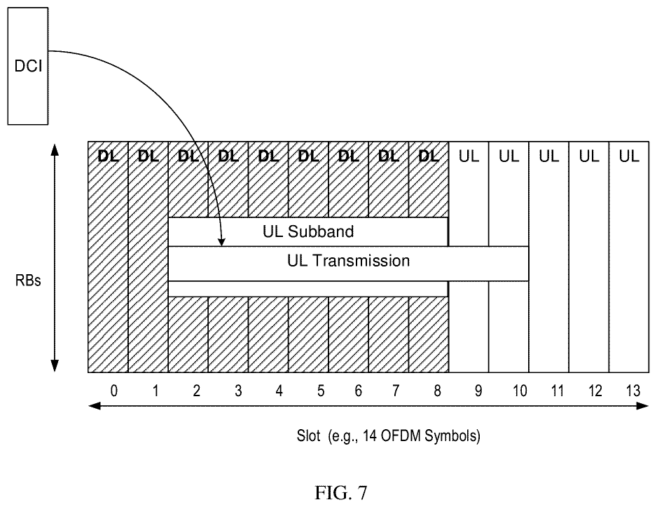

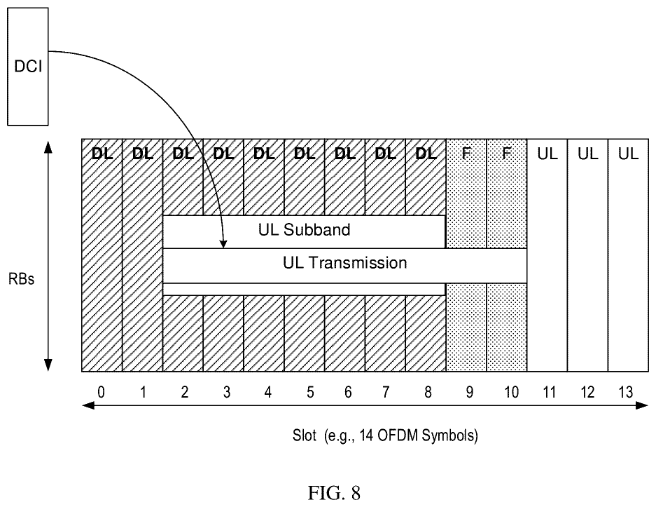

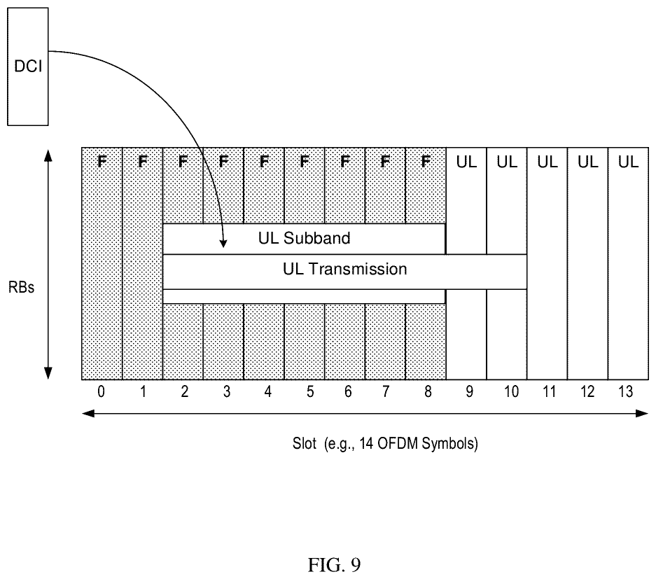

The examples illustrated in FIGS. 7-9 are similar to that of FIG. 6 with the difference being that (1) in FIG. 7, the additional symbols that may be scheduled by the DCI outside of the UL subband may be originally preconfigured UL symbols; (2) in FIG. 8, the additional symbols that may be scheduled by the DCI outside of the UL subband may be originally preconfigured F (flexible) symbols; and (3) in FIG. 9, the UL subband is configured (e.g., by RRC) in F symbols and the additional symbols that may be scheduled by the DCI outside of the UL subband may be originally preconfigured UL symbols. The underlying principles for scheduling the UL transmission apply to these situations.

In order to better support the above dynamic UL subband adjustment, corresponding UE capability may be introduced. In other words, a UE may either support or may not support dynamic UL subband adjustment for UL transmission. UE thus may report such capability or incapability to the base station. If the UE reports to the base station that such capability is supported at the UE, the base station may then dynamically schedule/configure the UE to perform the UE transmission outside of the symbols of the UL subband in the manners exemplarily described above. Otherwise, the base station would prohibits dynamically scheduling/configuring the UE to perform these UL transmission operations. For example, if the UE does not report the capability or explicitly report an incapability, the base station would refrain from scheduling a PUSCH/PUCCH/PRACH that exceeds the time domain range of the UL subband.

In some example implantations, as already alluded to above, the dynamic UL transmission scheduling and operation above may be limited to the frequency domain of the UL subband. For example, in the above example in FIGS. 6-9, for dynamically adjusted symbols #9 and #10 for UL transmission, only resources within the frequency domain of the UL subband may be dynamically scheduled as the frequency resources for the UL transmission. As such, the subband filter design and frequency locking may not need modification, among other advantages.

In some example implementations, in order to avoid/reduce the interference of DL transmission to UL transmission, some additional scheduling or configuration restrictions may be predefined and adopted. For example, in FIG. 6, for the symbols outside of the time-domain resources of the UL subband that are dynamically scheduled for UL PUSCH/PUCCH/PRACH transmission, the base station may not allow scheduling of DL transmissions within the frequency domain of the UL subband. In other words, DL transmission may be prohibited from being scheduled in symbol #9 and symbol #10 in the frequency resource range of the UL subband in FIG. 6.

### Dynamic Scheduling of DL Transmission in the Resources of the UL Subband

In some other situations, at some particular time, the UL subband as configured, for example, via RRC, may not be sufficiently utilized for UL transmission and that the DL traffic has become overly heavy, a dynamic scheduling may be implemented to use the UL subband for DL transmission. As such, in some example implementations, a method is provided to schedule DL transmission in the resources of the UL subband, so that the resources of the UL subband can be used for DL transmission in a dynamic manner. The underlying principle for dynamically scheduling UL transmission in the various implementations above in relation to FIGS. 6-9 applies to such dynamic DL transmission scheduling.

For example, in the case where the UE is configured with the UL subband by RRC signaling, if the UE is scheduled by the DCI in the PDCCH to perform a DL reception (that is, DL transmission by the base station) in resource A, and resource A overlaps with the resource of the UL subband in the time domain, then the UE should perform the DL reception from resource A.

In this case, the base station may ensure that the UE's UL transmission in the UL subband and DL reception using the UL subband resources do not overlap in the time domain. In this way, the resources of the UL subband can be dynamically used for DL reception (DL transmission by the base station), thereby realizing flexible and dynamic use of the resources of the UL subband.

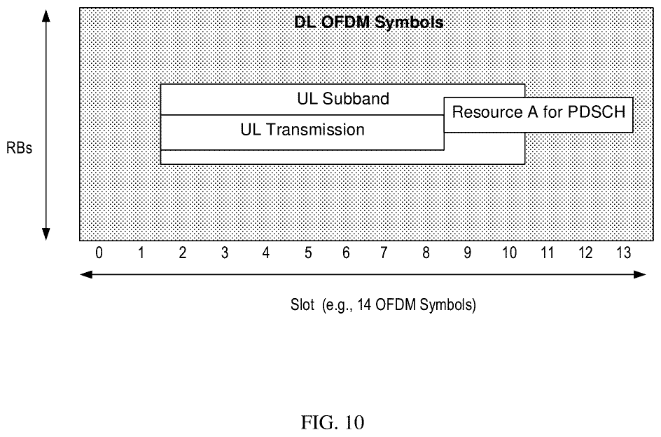

For another example, in the case where the UE is configured with UL subband by RRC signaling, if the base station schedules UL transmission to occupy some symbols in the UL subband, and the UL subband still has some idle symbols, then the base station can schedule DL transmission in the idle symbols, as shown in FIG. 10. For example, as illustrated in FIG. 10, a PDSCH for a DL transmission (by the base station) and a corresponding DL reception by the UE is scheduled to use symbols that are not used for UL transmission in the UL subband in addition to symbols outside of the UL subband (e.g., resource A is partially in UL subband and partially outside of UL subband in time-domain, as shown in FIG. 10). For the partial symbols of the UL subband that are used for the PDSCH transmission, a parameter can also be introduced into the DCI of the PDCCH scheduling the PDSCH, and a value of the parameter may be used to notify the UE to receive the PDSCH or not to receive the PDSCH in the UL subband. Alternatively, the base station may use a value of this parameter to notify the UE to ignore the PDSCH transmission in the UL subband time resources. In other words, the UE may consider that the part of the PDSCH transmission located in the UL subband is not transmitted.

The implementation of the parameter(s) or indicator for effectuation the dynamic DCI scheduling described above with respect to FIGS. 6-9 applies here for the scheduling of DL transmission/reception in UL subband. Likewise, the implementation described above relation to FIG. 6-9 and with respect to the capability of UE in supporting such dynamic scheduling, the reporting of the UE capability, and the operations by the UE and the base station based on such reporting can be applied here to the dynamic scheduling of DL transmission/reception in the UL subband.

Merely as an example, the parameter(s) related to dynamic scheduling can be configured for the UE by higher layer signaling (such as RRC signaling or MAC CE signaling). Once RRC configures the parameter to exist for the UE, the parameter is includable in the DCI for scheduling DL transmission that overlaps in time with the UL subband, otherwise the parameter is not included in the DCI scheduling.

Merely as another example, in order to better support the dynamic scheduling of DL transmission/reception in the UL subband time resources, corresponding UE capability may be introduced. If the UE reports to the base station that the capability is supported, that is, the UE can perform the above DL reception, the base station can schedule/configure the UE to perform the operations of dynamic DL reception partially in UL subband time resources. Otherwise, the base station prohibits scheduling/configuring the UE to perform such operations. For example, if the UE does not report the capability or report an incapability, the base station would prohibit scheduling a PDSCH to use the resources of the UL subband.

In order to avoid the interference of DL transmission to UL transmission, optionally, the following restrictions can be adopted: For example, in FIG. 5, in symbols #9 and #10 of the UL subband, one PDSCH is scheduled in the resources of the UL subband, then for the remaining frequency domain resources in symbol #9 and symbol #10 in the UL subband, UL transmission is prohibited. That is, within the resources of one UL subband, DL reception and UL transmission cannot be scheduled simultaneously even though DL reception and UL transmission are respectively for different UEs.

Similar to the example implementations above in relation to FIG. 6-9, in order to avoid/reduce the interference of DL transmission to UL transmission, some scheduling restrictions may be adopted. For example, in FIG. 10, in symbols #9 and #10, one PDSCH is scheduled in the resources of the UL subband, then for the remaining frequency domain resources in symbol #9 and symbol #10 in the UL subband, UL transmission may be prohibited (so as to reduce DL and UL interference with the UL subband in frequency). That is, within the resources of one UL subband, DL reception and UL transmission may not be scheduled simultaneously even when DL reception and UL transmission are respectively for different UEs.

### Intra-UL Subband Configuration

In some implementations, the base station, in addition to generally configure time-frequency resources of the UL subband for the UE (e.g., configuring some OFDM symbols in the time domain and some contiguous RBs in the frequency domain for the UL subband), may further configure some flexible resources within the resource range of the UL subband in either time-domain or frequency domain, or in both time and frequency domain. A flexible resource here is merely an appellation. It is actually a resource located in the UL subband, it is flexible and special in that this resource is allowed for DL transmission if needed even though it is part of the UL subband (obviously it can also be used for UL transmission because it belongs to the UL subband). For example, in the time domain, part of the OFDM symbols within the resource range of the UL subband may be configured to be flexible resources. For another example, in frequency domain, part of the RBs within the UL subband may be configured to be flexible resources. Within the time-frequency resource range of the UL subband, the transmission direction of the flexible resources can then be determined based on the transmission direction configured or scheduled by the base station.

This approach above is similar to the configuration of flexible symbols in the time slot structure. The configuration by the base station may be made semi-statically or dynamically. These flexible resources within the UL subband, if dynamically configure by the base station, may facilitate balancing of the resources for DL transmission and UL transmission in real-time.

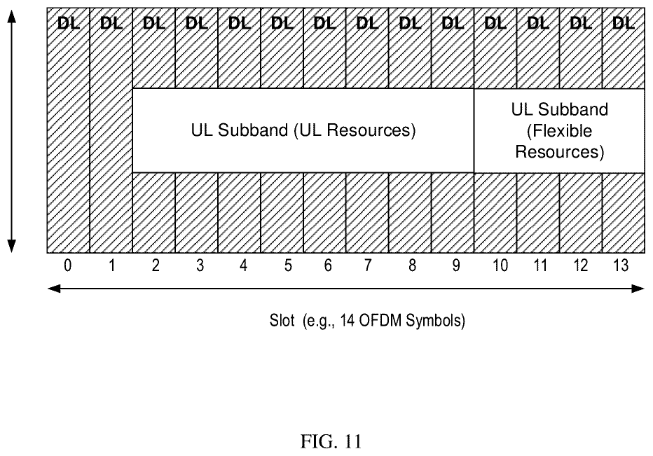

An example slot structure configured as based on the above-mentioned UL subband configuration is shown in FIG. 11 in the context of an originally configured DL slot having a semi-statically configured UL subband. All symbols are originally configured as DL symbols. FIG. 11 shows an example new slot structure with the UL subband of the SBFD UE configured with flexible resources according to the implementations above. In FIG. 11, the 3rd DL symbol to the 14th DL symbol are configured for the UL subband for the SBFD UE in the time domain and several consecutive RBs are configured for the UL subband in the frequency domain. The base station may further configure the 11th symbol to the 14th symbol in the time domain resources within the UL subband and across the entire frequency resource ranges of the UL subband as flexible resources of the UL subband. In this manner, in the time-frequency domain of the UL subband, these flexible resources can be used according to the direction of the transmission scheduled/configured by the base station over these flexible resources. The base station and UE can thus be scheduled to perform DL reception (by the UE) or UL transmission (from the UE) in the new slot structure using the flexible resources in the UL subband.

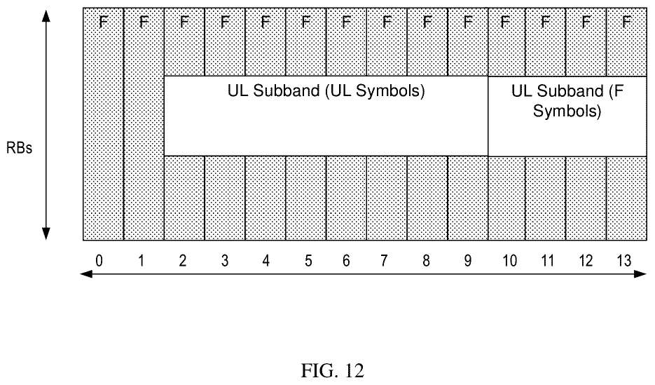

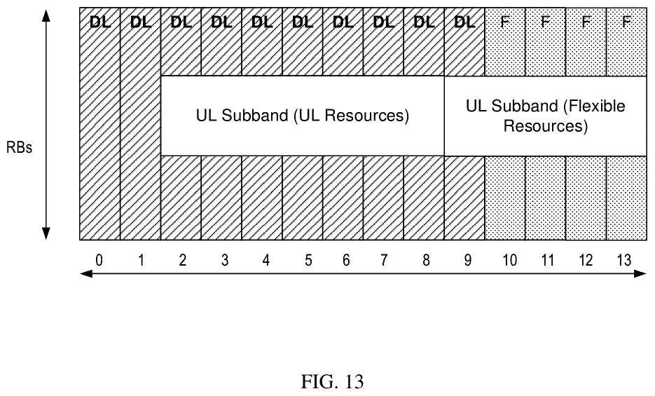

FIGS. 12 and 13 illustrates other example slot structure in which a UL subband is configured by the base station with flexible resources within the UL subband. The examples in FIGS. 12 and 13 are similar to that of FIG. 11, except that the slot as illustrated were originally configured as flexible slot (with all flexible symbols) and a mixed slot with mixed DL symbols and flexible symbols. The number of flexible symbols within the UL subband may be configured according to need for all of FIGS. 11-13. Further, for all of FIGS. 11-13, if the flexible symbols within the UL subband and the UL symbols within the UL subband need to interlaced, the slot structure can be so configured by the base station.

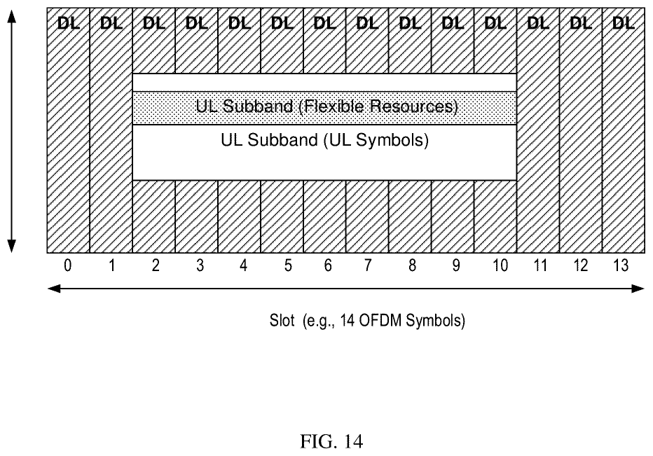

In the example illustrated in FIG. 14, the flexible resources within the UL subband are configured in frequency domain rather than time domain. In other words, a number of RBs of the UL subband may be configured as flexible RBs. As specifically shown in FIG. 14, the base station may configure a new slot structure. In FIG. 14, the slot is originally configured as a DL slot containing all DL symbols. The 3rd DL symbol to the 14th DL symbol are configured for the UL subband for the SBFD UE in the time domain and several consecutive RBs are configured for the UL subband in the frequency domain. The base station may then further configure some RBs in the frequency domain resources of the UL subband and across all symbols of the UL subband in time domain as flexible resources of the UL subband. In this manner, in the time-frequency domain of the UL subband, these flexible resources can be used according to the direction of the transmission scheduled/configured by the base station in the flexible resources. The base station and UE may perform DL or UL transmission in the flexible resources within the UL subband of the new slot structure.

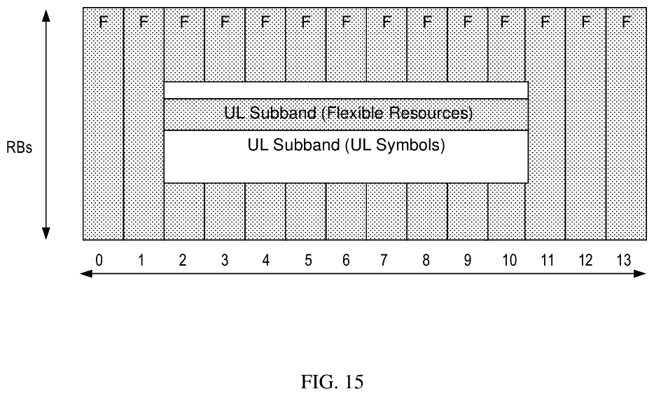

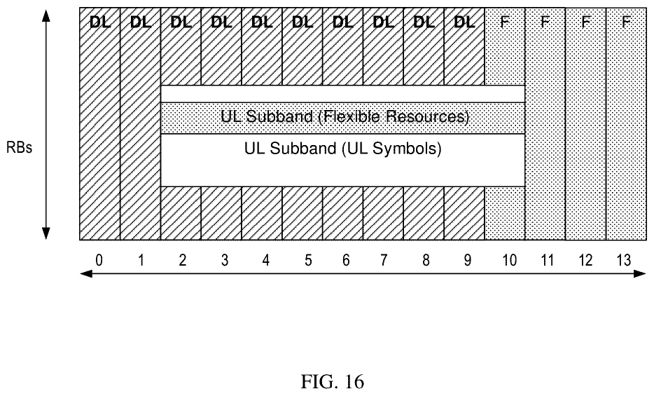

FIGS. 15 and 16 illustrates other example slot structure in which a UL subband is configured by the base station with flexible frequency resources within the UL subband. The examples in FIGS. 12 and 13 are similar to that of FIG. 14, except that the slot as illustrated were originally configured as flexible slot (with all flexible symbols) and a mixed slot with mixed DL symbols and flexible symbols. The number of flexible RB resources within the UL subband may be configured according to need for all of FIGS. 14-16. Further, for all of FIGS. 14-16, if the flexible bands of RBs within the UL subband and the UL symbols within the UL subband need to interlaced, the slot structure can be so configured by the base station.

An example configuration implementation is further described below as performed by the base station and the UE includes. The base station may configure the UL subband for the UE based on RRC signaling. The base station may also configure the flexible resources of the UL subband for the UE within the time-frequency resources of the UL subband simultaneously or subsequently, as described above, based on, for example, RRC signaling, MAC CE signaling, DCI signaling and the like. The base station can schedule/configure UL reception or DL transmission over the flexible resource within the UL subband for UEs with corresponding capabilities.

From the UE side, the UE receives the RRC signaling for configuring the UL subband from the base station to obtain a UL subband. The UE simultaneously or subsequently receives signaling for configuring flexible resources within the UL subband from the base station, and obtains the UL subband with flexible resources. The UE may then receive scheduling/configuration signaling from the base station, and performs UL transmission or DL reception within the UL subband over the flexible resources.

In some further implementations, with respect to scheduling of UL transmission or DL reception in the UL subband with flexible resources, the principle underlying FIGS. 6-10 apply and can be combined, in terms of, for example, DCI design, UL transmission and DL reception, adaptive modification is sufficient.

Further, in order to simplify UE design and support the UL subband with flexible resources, corresponding UE capability are also introduced. If the UE reports this capability, the base station can configure the UL subband with flexible resources for the UE and allow scheduling of UL transmission or DL reception in the UL subband. Otherwise, if the UE does not report this capability or explicitly report incapability, the base station would prohibit configuring the UL subband with flexible resources for the UE.

### Embodiment 4

Allowing for DL reception in the UL subband can facilitate dynamically balancing DL and UL resources. But when DL reception is allowed in UL subband, such DL reception may overlap in time-domain with other possible UL transmission also in the UL subband. Even though such DL reception and UL transmission may be on different RBs, they may need to avoid in order to not complicate the air interface design. In addition, some DL receptions may be scheduled or configured outside the UL subband, and may potentially overlap in time with a DL reception or UL transmission in the UL subband. This, for the same reason above, may need to be avoided. As such, some predefined options and rules may need to be specified for avoiding these overlapping transmissions/receptions and to select a transmission or reception when conflict occurs.

Generally, UL transmission herein includes but is not limited to semi-statically configured PUSCH/PUCCH and dynamically scheduled PUSCH/PUCCH. Likewise, DL reception herein includes but is not limited to semi-statically configured SPS PDSCH/CSI-RS/DL PRS, and dynamically scheduled PDSCH/CSI-RS/DL PRS

### Option 1: Prioritize UL Subband

In some example implementations, the base station may configure a priority or priority level for the UL subband of the UE. The conflict described above may then be resolved according the various priorities.

For example, for a DL reception, if its priority is higher than that of the UL subband, the DL reception may then be allowed to be scheduled or configured in the UL subband by the base station. Otherwise, the DL reception may be prohibited from being scheduled or configured in the UL subband.

Likewise, under such rule, if predefined, the UE would not expect a DL reception to be scheduled or configured within a UL subband if the priority of the DL reception is lower than or equal to the priority of the UL subband. In such a situation, the UE would not receive/process the DL reception. Also under such a rule, if a DL reception is scheduled or configured within a UL subband, the base station should ensure that such DL reception has a higher priority than that of the UL subband.

In some example implementations, the priority of the UL subband as configured by the base station above may not be considered valid for UL transmission. In other words, even if the priority of a UL transmission is different from the priority of the UL subband, the UL transmission can always be scheduled or configured within the UL subband. The base station could ignore the UL subband priority when scheduling/configuring UL transmission in the UL subband.

In some further example implementations, within the UL subband, if a DL reception and a UL transmission overlap in the time domain, the higher priority channel/signal can survive and be transmitted, and the lower priority channel/signal is discarded for transmission/reception. Within the UL subband, the UE would not expect DL reception and UL transmission of the same priority to overlap in the time domain. As such, the base station should ensure during scheduling process that DL reception and UL transmission of the same priority within the UL subband do not overlap in the time domain.

### Option 2—Absolute Priority and Same-Priority Resolution

In some example implementations, the base station and the UE may agree based on a preestablished rule that if the time domain overlaps between DL receptions of the same priority, or between a DL reception and a UL transmission of the same priority, or between UL transmissions of the same priority, then the DL reception or UL transmission in the UL subband is survived, and the DL reception or UL transmission outside the UL subband are discarded.

Within the UL subband, the UE would accordingly not expect DL reception and UL transmission of the same priority to overlap in the time domain. Therefore, the base station should ensure that DL reception and UL transmission of the same priority within the UL subband do not overlap in the time domain.

In some other example implementations, DL reception and UL transmission with the same priority in the UL subband overlap in the time domain, and the base station and the UE may agree that UL transmission is always survived, whereas DL reception is discarded, for the reason that UL transmission should be preferentially transmitted in the UL subband. In some other example implementations, the DL reception and UL transmission of the same priority in the UL subband overlap in the time domain, and the base station and the UE may agree that the DL reception is always survived and the UL transmission is discarded if, for example, the base station and the UE agree that the DL reception is to be scheduled in the UL subband only in emergency situations, so that the DL reception should be preferentially transmitted.

If channels/signals of different priorities (DL reception/UL transmission) overlap in the time domain, regardless of whether they are in the UL subband, then higher priority channels/signals can survive and be transmitted, lower priority channels/signals Transmission was abandoned.

### Option 3-No Time Overlap Allowed Between DG PDSCH and DG PUSCH/PUCCH in UL Subband

In some example implementations, within the UL subband, if the dynamic PDSCH (DL transmission) (denoted as DG PDSCH) scheduled by the PDCCH and the dynamic PUSCH/PUCCH (UL transmission) (denoted as DG PUSCH/PUCCH) scheduled by the PDCCH overlap in the time domain, the following rules may be predefined and considered.

For example, If the DG PDSCH is allowed to be transmitted in the UL subband, then the base station and the UE may agree according to a predefined rule that the base station always ensures that the DG PDSCH and the DG PUSCH/PUCCH do not overlap in the UL subband in the time domain. Otherwise, if a DG PDSCH or DG PUSCH/PUCCH is scheduled in a certain time domain resource in the UL subband, then DG PUSCH/PUCCH or DG PDSCH cannot be scheduled in this time domain resource, so as to avoid their time domain overlapping. From the UE's perspective, the UE would not expect that one DG PDSCH and one DG PUSCH/PUCCH overlap in time domain within the UL subband. If they overlap in the time domain, the UE does not process them and considers the situation as a base station scheduling error.

### Option 4-DG PDSCH and DG PUSCH/PUCCH in UL Subband: Scheduling Time-Based

In some example implementations, in the UL subband, if the DG PDSCH scheduled by the PDCCH and the DG PUSCH/PUCCH scheduled by the PDCCH overlap in the time domain, and if they have the same priority, one of the following rules may be predefined and implemented.

### Rule 1

If the DG PDSCH is scheduled by PDCCH1, and DG PUSCH/PUCCH is scheduled by PDCCH2, and DG PDSCH and DG PUSCH/PUCCH overlap in the UL subband in time domain, then the DG PDSCH or DG PUSCH/PUCCH corresponding to the PDCCH with the later start (or end) symbol between PDCCH1 and PDCCH2 survives for transmission, whereas the DG PDSCH or DG PUSCH/PUCCH corresponding to the PDCCH with the earlier start (or end) symbol is discarded.

For example, if the start (or end) symbol of PDCCH1 is later than the start (or end) symbol of PDCCH2, the DG PDSCH survives and the DG PUSCH/PUCCH is discarded. If the start (or end) symbol of PDCCH2 is later than the start (or end) symbol of PDCCH1, the DG PUSCH/PUCCH is survived and the DG PDSCH is discarded.

### Rule 2

Opposite to Rule 1 above, if DG PDSCH is scheduled by PDCCH1, and DG PUSCH/PUCCH is scheduled by PDCCH2, and DG PDSCH and DG PUSCH/PUCCH overlap in the UL subband in time domain, then the DG PDSCH or DG PUSCH/PUCCH corresponding to the PDCCH with the earlier start (or end) symbol between PDCCH1 and PDCCH2 is survived, and the DG PDSCH or DG PUSCH/PUCCH corresponding to the PDCCH with the later start (or end) symbol is discarded.

For example, if the start (or end) symbol of PDCCH1 is earlier than the start (or end) symbol of PDCCH2, the DG PDSCH survives for transmission and the DG PUSCH/PUCCH is discarded. If the start (or end) symbol of PDCCH2 is earlier than the start (or end) symbol of PDCCH1, the DG PUSCH/PUCCH survives for transmission and the DG PDSCH is discarded.

### Rule 3

If DG PDSCH is scheduled by PDCCH1, and DG PUSCH/PUCCH is scheduled by PDCCH2, and DG PDSCH and DG PUSCH/PUCCH overlap in the UL subband in time domain, and one of them has multiple repeated transmissions, then the channel with repeated transmission survives for transmission, and the channel without repeated transmission is discarded.

For example, if the DG PDSCH is scheduled with repeated transmission, and the DG PUSCH/PUCCH is scheduled without repeated transmission, then the DG PDSCH is survived whereas the DG PUSCH/PUCCH is discarded. For another example, if DG PDSCH is scheduled without repeated transmission, and DG PUSCH/PUCCH is scheduled with repeated transmission, then DG PUSCH/PUCCH is survived whereas DG PDSCH is discarded.

### Rule 4

If DG PDSCH is scheduled by PDCCH1, and DG PUSCH/PUCCH is scheduled by PDCCH2, and DG PDSCH and DG PUSCH/PUCCH overlap in the UL subband in time domain, and they both have multiple repeated transmissions, then Rule 1 or Rule 2 above may be used to determine which them is survived and which one is discarded.

### Option 5-DG PDSCH and CG PUSCH/PUCCH in UL Subband: Scheduling Time-Based or Presumed Priority

In some example implementations, in the UL subband, if the DG PDSCH scheduled by the PDCCH and a semi-static/configured grant PUSCH/PUCCH (denoted as CG PUSCH/PUCCH) overlap in the time domain, and if they have the same priority, one of the following rules may be predefined and considered.

### Rule 5

If there is at least T duration between the end of the end symbol of the PDCCH corresponding to the DG PDSCH and the beginning of the start symbol of the CG PUSCH/PUCCH, then the DG PDSCH is survived and transmitted, whereas the CG PUSCH/PUCCH is discarded. Otherwise, the CG PUSCH/PUCCH is survived and transmitted, and the DG PDSCH is discarded. Here the start of the T duration is from the end of the end symbol of the PDCCH.

Here, the T duration may be defined as follows. T may be defined based on N1 in the existing protocol TS38.213, or defined based on N2 in the existing protocol TS38.213, or may be defined as 14 symbols.

### Rule 6

In some implementations, CG PUSCH/PUCCH is always survived and transmitted, DG PDSCH is discarded. In other words, when they overlap in the UL subband in time domain, higher priority may be given to UL transmission.

### Option 6-SPS PDSCH and DG PUSCH/PUCCH in UL Subband: Scheduling Time-Based or Presumed Priority

In some example implementations, in the UL subband, if the semi-static PDSCH (denoted as SPS PDSCH) and the dynamic PUSCH/PUCCH (denoted as DG PUSCH/PUCCH) scheduled by the PDCCH overlap in the time domain, and if they have the same priority, one of the following rules may be predefined and considered.

### Rule 7

If there is at least Q duration between the end of the end symbol of the PDCCH corresponding to the DG PUSCH/PUCCH and the beginning of the start symbol of the SPS PDSCH, then the DG PUSCH/PUCCH is survived and transmitted, whereas the SPS PDSCH is discarded; Otherwise, the SPS PDSCH is survived and transmitted. DG PUSCH/PUCCH is discarded. Here the start of the Q duration is from the end of the end symbol of the PDCCH.

Here, the Q duration may be defined as follows. Q may be defined based on N1 in the existing protocol TS38.213, or defined based on N2 in the existing protocol TS38.213, or may be defined as 14 symbols.

### Rule 8

In some example implementations, the DG PUSCH/PUCCH is always survived and transmitted, SPS PDSCH is discarded. Due to their time domain overlap is in the UL subband, UL transmissions may be given higher priority. In other words, if the resources of the DG PUSCH/PUCCH and SPS PDSCH scheduled/configured by the base station for the SBFD UE overlap in the time domain in the UL subband, the base station considers that the UE transmits the DG PUSCH/PUCCH, so the base station does not transmit the SPS PDSCH. The UE finds that the resources of the DG PUSCH/PUCCH and the SPS PDSCH overlap in the time domain of the UL subband, then the UE transmits the DG PUSCH/PUCCH, and the UE does not receive the SPS PDSCH under this rule.

### Option 7—SPS PDSCH and CG PUSCH/PUCCH in UL Subband

In some example implementations, in the UL subband, if the SPS PDSCH and the CG PUSCH/PUCCH overlap in the time domain, and if they have the same priority, one of the following rules may be predefined and considered.

### Rule 9

Under this example rule, CG PUSCH/PUCCH is always survived and transmitted, SPS PDSCH is discarded. Because their time domain overlap is in the UL subband, and UL transmissions may be given higher priority. In other words, if the resources of the CG PUSCH/PUCCH and SPS PDSCH configured by the base station for the SBFD UE overlap in the time domain in the UL subband, the base station may consider under this rule that the UE transmits the CG PUSCH/PUCCH, so the base station does not transmit the SPS PDSCH. The UE may find under this example rule that the resources of the CG PUSCH/PUCCH and the SPS PDSCH overlap in the time domain of the UL subband, then the UE transmits the CG PUSCH/PUCCH, and the UE does not receive the SPS PDSCH.

### Rule 10

The UE does not expect the CG PUSCH/PUCCH and SPS PDSCH to overlap in the time domain in the UL subband. That is, the base station configures CG PUSCH/PUCCH and SPS PDSCH for the SBFD UE, and the base station should ensure that the resources of CG PUSCH/PUCCH and SPS PDSCH in the UL subband do not overlap in the time domain. Under this rule, if the UE finds that the resources of the CG PUSCH/PUCCH and the SPS PDSCH in the UL subband are overlapping in the time domain, the UE does not perform any reception and transmission.

### Transmission of DL Reference Signal in UL Subband

In some example implementations, downlink reference signals, like general DL transmission, may be allowed to be transmitted within the resources of the UL subband. The downlink reference signals here include but are not limited to reference signals for channel measurement (e.g., semi-static CSI-RS (channel state information reference signal) or CSI-RS triggered based on PDCCH) or reference signals for positioning (e.g., DL PRS). If the reference signal is configured to use the resources of the UL subband (for example, a symbol in the UL subband) for transmission, then UE and base station may consider one of the following implementations, where the resource of the UL subband used for transmitting the reference signal is denoted as resource B.

1) When the reference signal is for SBFD capable UE:
In some example implementations, the reference signal is always sent on resource B. If an SBFD UE's UL transmission is scheduled/configured to include resource B, then the SBFD UE should be instructed to perform rate matching for resource B. In other words, the UL transmission is punctured on resource B, that is, the UL transmission skips resource B. Specifically, the UE uses UL subband resource other than the resource B for the UL transmission.
In some alternative example implementations, if no UL transmission of any SBFD UE is scheduled/configured to include resource B, then the reference signal is transmitted in resource B. Otherwise, the base station does not transmit the reference signal in resource B. The base station should indicate by signaling to the UE whether the reference signal is transmitted on resource B for the SBFD UE.
In some other alternative example implementations, the base station explicitly signals to the UE whether resource B is used for reference signal or UL transmission. The UE correspondingly determines whether resource B is used for the reference signal or resource B is used for UL transmission according to the signaling of the base station. The signaling may be RRC signaling/MAC CE, or the signaling may be DCI signaling (e.g., in the DCI that schedules the UL transmission).
In some other alternative implementations, when the UE requests the reference signal, the UE may simultaneously inform the base station whether the reference signal is to be transmitted in resource B. For example, when the UE needs to request the reference signal, the UE sends a request signaling to the base station, and at the same time informs the base station in the request signaling (if the above resource B is known) that resource B is to be used for UL transmission, or resource B is used for reception the reference signal.
In some other alternative implementations, if an SBFD UE's DL PDSCH reception is scheduled/configured in resource C, and resource C contains resource B, and the DL PDSCH reception is determined to be received from the UE (that is, the base station determines that the DL PDSCH reception is transmitted in resource B)), the UE then considers that the reference signal is transmitted in resource B, but the DL PDSCH reception is transmitted in resource C except resource B (skip resource B).

2) The reference signal is for legacy UEs (or UE without SBFD capability):
In some implementations, the reference signal is always sent on resource B. So that the legacy UEs will receive the reference signal. An SBFD capable UE shall rate match on this resource B if the UL transmission of the SBFD UE is scheduled/configured to include resource B. The SBFD UE always performs rate matching on resource B, or the SBFD UE is signaled whether to perform rate matching on resource B.

### Solving the Overlapping of NACK-Only PUCCHs of Different Priorities in the Time Domain

In some embodiments, the network may configure a priority for a physical channel for a UE. When a first physical channel with higher priority overlaps with a second physical channel with lower priority in the time domain, the first physical channel may cancel the second physical channel. It implies that the UE may drop (or cancel) the second physical channel transmission and just transmit the first physical channel. Alternatively, the UE may drop the information of the second physical channel or may not multiplex the information of the second physical channel in the first physical channel.

The network may configure NACK-only feedback mode for the UE. The configured NACK-only feedback mode may be applied for a physical downlink shared channel (PDSCH). For the PDSCH, the network may configure or indicate a NACK-only physical uplink control channel (PUCCH). When the UE decode the PDSCH correctly, the UE may not transmit the NACK-only PUCCH. When the UE does not decode the PDSCH correctly, the UE may transmit the NACK-only PUCCH.

A first NACK-only PUCCH may correspond a first group of PDSCHs. The first group of PDSCHs may include one or more PDSCHs. The first NACK-only PUCCH with higher priority overlaps with a second physical channel with lower priority in the time domain. In some embodiments, the first NACK-only PUCCH with higher priority may cancel the second physical channel with lower priority. It implies that the UE may drop (or cancel) the second physical channel transmission regardless of the decoding results of the first group of PDSCHs. More specifically, the UE may drop (or cancel) the second physical channel even though the UE decode the first group of PDSCHs correctly. When the UE decode the first group of PDSCHs correctly, the UE may not transmit the first NACK-only PUCCH or the UE may not transmit anything. The UE may determine the PUCCH resource according to the decoding results of the first group of PDSCHs only.

In some embodiments, the first NACK-only PUCCH with higher priority may not cancel the second physical channel with lower priority. Further, the first NACK-only PUCCH with higher priority may not cancel the second physical channel with lower priority when the UE decodes the first group of PDSCHs correctly. It implies that the UE may transmit the second physical channel when the UE decodes the first group of PDSCHs correctly.

A second NACK-only PUCCH may correspond a second group of PDSCHs. The second group of PDSCHs may include one or more PDSCHs. The first NACK-only PUCCH with higher priority overlaps with the second NACK-only PUCCH with lower priority in the time domain. The first NACK-only PUCCH with higher priority may not cancel the second NACK-only PUCCH with lower priority. The UE may determine the PUCCH resource according to the decoding results of both of the first group of PDSCHs and the second group of PDSCHs.

Further, the first NACK-only PUCCH with higher priority may not cancel the second NACK-only PUCCH with lower priority when the UE decodes the first group of PDSCHs correctly. The UE may transmit the first NACK-only PUCCH when the UE does not decode at least one of the first group of PDSCHs. The UE may transmit the second NACK-only PUCCH when the UE decode the first group of PDSCHs correctly and does not decode at least one of the second group of PDSCHs. The UE may not transmit the first NACK-only PUCCH or the second NACK-only PUCCH when the UE decode the first group of PDSCHs correctly and decode the second group of PDSCHs correctly.

With the embodiments, the UE can avoid unnecessary dropping or cancellation and therefore the spectrum efficiency can be improved.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method, performed by a wireless access network node, comprising:
configuring an uplink subband for uplink transmission for a user equipment (UE) based on a first signaling, the uplink subband occupying a contiguous resource blocks in frequency and a set of symbols in time within a first set of resources,
wherein:
flexible resources are configured by a second signaling for the uplink subband in resources of the uplink subband; or
a portion of resources of the uplink subband are allowed to be configured by the second signaling as flexible resources; and
wherein:
the first set of resources are configured as downlink or direction-flexible resources to the UE, and
the first signaling is used to configure time-frequency resources of the uplink subband.

2.-16. (canceled)

17. A method, performed by a wireless access network node, comprising:
configuring an uplink subband for uplink transmission for a user equipment (UE) based on a first signaling, the uplink subband occupying a contiguous resource blocks in frequency and a set of OFDM symbols in time within a first set of resources; and
transmitting a downlink transmission in the configured uplink subband,
wherein:
the first set of resources are configured as downlink or direction-flexible resources to the UE, and
the first signaling is used to configure time-frequency resources of the uplink subband.

18.-31. (canceled)

32. A method, performed by a wireless terminal device, comprising:
determining an uplink subband for uplink transmission based on a configuration from a wireless access network node, the uplink subband occupying a contiguous resource blocks in frequency and a set of symbols in time within a first set of resources,
wherein:
flexible resources are configured by a signaling for the uplink subband in resources of the uplink subband; or
a portion of resources of the uplink subband are allowed to be configured by the signaling as flexible resources; and
wherein:
the first set of resources are configured as downlink or direction-flexible resources to the wireless terminal device, and
the configuration is used for time-frequency resources of the uplink subband.

33. The method of claim 32, further comprising receiving a scheduling of a second set of resources for an uplink transmission from the wireless access network node, the second set of resources are partially within and partially outside of the uplink subband in time via a Downlink Control Information (DCI) message.

34. (canceled)

35. The method of claim 33, wherein a portion of the second set of resources outside of the uplink subband is implemented as a time-domain adjustment to the uplink subband.

36. The method of claim 35, wherein the time-domain adjustment to the uplink subband is only valid during the scheduling of the second set of resources for the uplink transmission, or is valid until a next time-domain adjustment to the uplink subband, or is valid for a predetermined or configured period of time following the scheduling of the second set of resources for the uplink transmission.

37. (canceled)

38. The method of claim 33, wherein the configuration of the uplink subband is transmitted in response to the wireless access network node receiving a capability report from the wireless terminal device, the capability report indicating that the wireless terminal device supports a subband full-duplex (SBFD) or the wireless terminal device supports using the second set of resources for the uplink transmission.

39. The method of claim 33, wherein the DCI message comprises:
one or more parameters indicating to the wireless terminal device a time and frequency location of the second set of resources; or
an indicator that indicates to the wireless terminal device that the uplink subband is to be extended according to the second set of resources.

40. (canceled)

41. The method of claim 33, wherein the wireless access network node is prohibited from further scheduling any resources that co-locate in time with a portion of the second set of resources that is outside of the uplink subband and within a frequency resource range of the uplink subband.

42. (canceled)

43. The method of claim 32, wherein:
transmission direction of the flexible resources is determined based on direction of transmissions scheduled in the flexible resources;
the flexible resources configured in the uplink subband comprise:
one or more OFDM symbols across an entire frequency range of the uplink subband; or
one or more frequency resource blocks across an entire OFDM symbol range of the uplink subband.

44.-46. (canceled)

47. The method of claim 32, wherein the flexible resources are configured in response to the wireless access network node receiving a capability report from the wireless terminal device, the capability report indicating that the wireless terminal device supports a subband full-duplex (SBFD) or the wireless terminal device supports the flexible resources in the uplink subband.

48. A method, performed by a wireless terminal device, comprising:
determining an uplink subband for uplink transmission based on a configuration from a wireless access network node, the uplink subband occupying a contiguous resource blocks in frequency and a set of OFDM symbols in time within a first set of resources; and
receiving a downlink transmission in the configured uplink subband from the wireless access network node,
wherein:
the first set of resources are configured as downlink or direction-flexible resources to the wireless terminal device, and
the configuration is used for time-frequency resources of the uplink subband.

49. The method of claim 48, wherein receiving the downlink transmission in the configured uplink subband comprises receiving a signaling from the wireless access network node to schedule the downlink transmission in at least one portion of the uplink subband that corresponds to no other portions of the uplink subband that overlap with the at least one portion of the uplink subband and that are scheduled for uplink transmission.

50. (canceled)

51. (canceled)

52. The method of claim 49, wherein the wireless access network node is prohibited from further scheduling an uplink transmission over second set of resources overlapping with the at least one portion of the configured uplink subband in time and within a frequency resource range of the configured uplink subband.

53. The method of claim 48, further comprising determining a first priority level for the uplink subband, the first priority level being used as a basis for determining whether a downlink transmission is allowed to be scheduled in the uplink subband; wherein:
the downlink transmission is allowed if the first priority level of the uplink subband is lower than a second priority level associated with the downlink transmission; and
the downlink transmission is prohibited if first priority level of the uplink subband is higher than the second priority level associated with the downlink transmission.

54. (canceled)

55. The method of claim 48, further comprising resolving scheduling conflict between two downlink transmissions or between a downlink transmission and uplink transmission of a same priority with time overlap within the uplink subband by retaining a transmission inside a frequency range of the uplink subband and by discarding the transmission outside the frequency range of the uplink subband.

56. The method of claim 48, further comprising prohibiting scheduling a dynamic PDSCH downlink transmission and a dynamic PUSCH/PUCCH by a same PDCCH with overlapping time within the uplink subband.

57. The method of claim 48, further comprising resolving a scheduling conflict between a dynamic PDSCH downlink transmission and a dynamic PUSCH/PUCCH uplink transmission overlapping in time within the uplink subband based on a timing of respective scheduling PDCCH for the dynamic PDSCH downlink transmission and the dynamic PUSCH/PUCCH uplink transmission.

58. The method of claim 48, further comprising resolving a scheduling conflict between a dynamic PDSCH downlink transmission and a semi-static PUSCH/PUCCH uplink transmission overlapping in time within the uplink subband:
based on an OFDM symbol level time separation between respective scheduling PDCCH for the dynamic PDSCH downlink transmission and the semi-static PUSCH/PUCCH uplink transmission; or
by retaining the semi-static PUSCH/PUCCH uplink transmission and by discarding the dynamic PDSCH downlink transmission.

59. (canceled)

60. The method of claim 48, further comprising resolving a scheduling conflict between a semi-static PDSCH downlink transmission and a dynamic or semi-static PUSCH/PUCCH uplink transmission overlapping in time within the uplink subband by retaining the dynamic or semi-static PUSCH/PUCCH uplink transmission and by discarding the semi-static PDSCH downlink transmission.

61.-64. (canceled)
